(19) United States
(12) Patent Application Publication
(10) Pub. No.: US 2026/0128881 A1
(43) Pub. Date: May 7, 2026

(54) SEMICONDUCTOR DEVICE AND CONTROL METHOD OF SEMICONDUCTOR DEVICE

(71) Applicant: Renesas Electronics Corporation, Tokyo (JP)

(72) Inventors: Hiroki ISHIGURO, Tokyo (JP); Kosuke SHIBUYA, Tokyo (JP); Kazuki MOCHIZUKI, Tokyo (JP); Kyohei KIDA, Tokyo (JP)

(21) Appl. No.: 19/318,478

(22) Filed: Sep. 4, 2025

(30) Foreign Application Priority Data
Nov. 1, 2024 (JP) 2024-192785

(51) Int. Cl. H04L 9/30; H04L 9/08

(52) U.S. Cl. CPC H04L 9/3073; H04L 9/0894

(57) ABSTRACT

A method for controlling a semiconductor device capable of ensuring robust security is provided. The method is implemented by a semiconductor device comprising an encryption key protection circuit, a processor, and a memory. It includes instructing, by the processor, the encryption key protection circuit to generate an encryption key pair, generating, by the encryption key protection circuit, the encryption key pair internally according to the instruction, encrypting, by the encryption key protection circuit, the generated encryption key pair using a common key, storing, by the processor, the encrypted encryption key pair output from the encryption key protection circuit into the memory, receiving, by the encryption key protection circuit, the encrypted encryption key pair stored in the memory when utilizing the encryption key pair, and decrypting, by the encryption key protection circuit, the encrypted encryption key pair received from the memory using the common key.

### CROSS-REFERENCE TO RELATED APPLICATIONS

The disclosure of Japanese Patent Application No. 2024-192785 filed on Nov. 1, 2024, including the specification, drawings and abstract is incorporated herein by reference in its entirety.

### BACKGROUND

The present disclosure relates to a semiconductor device, particularly to a semiconductor device with a cryptographic key protection circuit and its control method.

There are disclosed techniques listed below.
[Patent Document 1] Japanese Unexamined Patent Application Publication No. 2021-184584

Conventionally, semiconductor devices have been proposed that hold both a device-specific key and a common key and utilize a cryptographic key protection circuit capable of performing encryption and decryption using the device-specific key and decryption using the common key. The cryptographic key protection circuit performs an activation process where data encrypted with the common key is decrypted using the common key, then encrypted using the device-specific key, and written to non-volatile memory. After the activation process, the encrypted data is read from the non-volatile memory, and the cryptographic key protection circuit decrypts it using the device-specific key to supply it to the processor.

### SUMMARY

On the other hand, conventional methods have aspects that could be further improved in terms of security regarding the generation of device-specific keys.

The present disclosure has been made to solve the above issues and provides a semiconductor device and a control method for the semiconductor device that can ensure robust security.

Other objects and novel features will become apparent from the description of this specification and the accompanying drawings.

The method of the present disclosure is implemented by a semiconductor device comprising a cryptographic key protection circuit, a processor, and a memory. The method includes: instructing, by the processor, the encryption key protection circuit to generate an encryption key pair; generating, by the encryption key protection circuit, the encryption key pair internally according to the instruction; encrypting, by the encryption key protection circuit, the generated encryption key pair using a common key; storing, by the processor, the encrypted encryption key pair output from the encryption key protection circuit in the memory; receiving, by the encryption key protection circuit, when using the encryption key pair, the encrypted encryption key pair stored in the memory; and decrypting, using the common key by the encryption key protection circuit, the encrypted encryption key pair received from the memory.

The semiconductor device of the present disclosure includes a cryptographic key protection circuit, a processor that instructs the cryptographic key protection circuit to generate a cryptographic key pair, and a memory. The encryption key protection circuit comprises: an encryption key generation unit that generates the encryption key pair internally according to instructions from the processor; an encryption unit that encrypts the generated encryption key pair using a common key and outputs the encrypted encryption key pair for storage in the memory; and a decryption unit that decrypts the encrypted encryption key pair stored in the memory using the common key when utilizing the encryption key pair.

The method of the present disclosure is implemented by a semiconductor device comprising a protection circuit with guaranteed appropriate security strength, a processor, and a memory. The method includes: instructing, by the processor, the protection circuit to generate an encryption key pair; generating, by the protection circuit, an encryption key pair internally according to the instruction; encrypting, by the protection circuit, the generated encryption key pair using a common key; storing, by the processor, the encrypted encryption key pair output from the protection circuit in the memory; receiving, by the protection circuit, when using the encryption key pair, the encrypted encryption key pair stored in the memory; and decrypting, using the common key by the protection circuit, the encrypted encryption key pair received from the memory.

Another semiconductor device of the present disclosure includes a protection circuit with guaranteed appropriate security strength; a processor that instructs the protection circuit to generate an encryption key pair; and a memory. The protection circuit comprises: an encryption key generation unit that generates the encryption key pair internally according to instructions from the processor; an encryption unit that encrypts the generated encryption key pair using a common key and outputs the encrypted encryption key pair for storage in the memory; and a decryption unit that decrypts the encrypted encryption key pair stored in the memory using the common key when utilizing the encryption key pair.

The semiconductor device and the control method of the semiconductor device of the present disclosure can ensure robust security.

### BRIEF DESCRIPTION OF THE DRAWINGS

FIG. 1 is a block diagram illustrating the configuration of a semiconductor system 1 according to an embodiment of the present disclosure.

FIG. 2 is a flowchart illustrating the generation of a cryptographic key pair in a semiconductor device 15 according to an embodiment of the present disclosure.

FIG. 3 is a flowchart illustrating the key generation process of a cryptographic key protection circuit 14 according to an embodiment of the present disclosure.

FIG. 4 is a flowchart illustrating the use of a cryptographic key pair in a semiconductor device 15 according to an embodiment of the present disclosure.

FIG. 5 is a flowchart illustrating the cryptographic key extraction process of a cryptographic key protection circuit 14 according to an embodiment of the present disclosure.

FIG. 6 is a diagram illustrating an example of the use of a cryptographic key pair according to an embodiment of the present disclosure.

### DETAILED DESCRIPTION

The embodiments will be described in detail with reference to the drawings. In the drawings, the same or corresponding components are denoted by the same reference numerals, and description thereof will not be repeated.

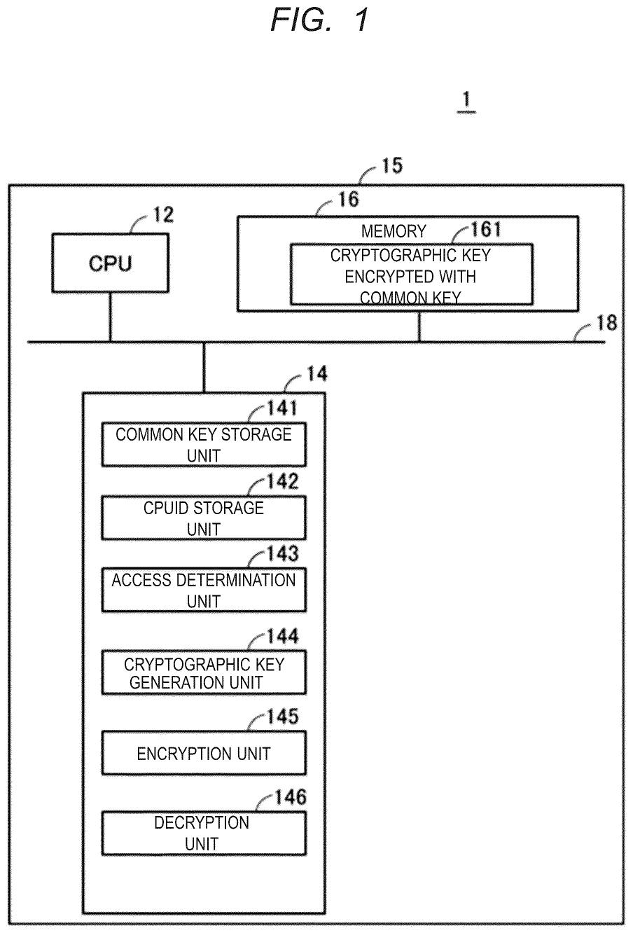

FIG. 1 is a block diagram illustrating the configuration of a semiconductor system 1 according to an embodiment of the present disclosure. Referring to FIG. 1, the semiconductor system 1 includes a semiconductor device 15. Although not shown, the semiconductor device 15 can be connected to other communication semiconductor devices, peripherals, external memory, etc., and is provided to be mountable on a system board.

The semiconductor device 15 constitutes a microcontroller and includes a central processing unit (CPU) 12, a memory 16, a cryptographic key protection circuit 14, and a bus 18. The cryptographic key protection circuit 14 is a protection circuit with guaranteed appropriate security strength as a security IP. These are interconnected via the bus 18. Memory 16 holds an encrypted cryptographic key pair 161 encrypted with a common key, which will be described later. The cryptographic key protection circuit 14 has functions for key management and blocking processing from the CPU 12 that has not been pre-authorized. The cryptographic key protection circuit 14 includes various functional blocks. Specifically, the cryptographic key protection circuit 14 includes a common key storage unit 141, a CPUID storage unit 142, an access determination unit 143, a cryptographic key generation unit 144, an encryption unit 145, and a decryption unit 146.

The common key storage unit 141 stores the common key in a state where it cannot be read from outside the cryptographic key protection circuit 14. In this regard, the common key may be stored in the common key storage unit 141 within the cryptographic key protection circuit 14 by a special command. Alternatively, it may be embedded internally during the assembly of the cryptographic key protection circuit 14.

The CPUID storage unit 142 stores the identifier CPUID of the CPU that is allowed to access. In this regard, the identifier CPUID may be stored in the CPUID storage unit 142 within the cryptographic key protection circuit 14 by a special command. Alternatively, it may be embedded during the assembly of the cryptographic key protection circuit 14. Alternatively, the identifier CPUID of the CPU that first accesses the cryptographic key protection circuit 14 may be stored in the CPUID storage unit 142.

The access determination unit 143 determines whether the access to the cryptographic key protection circuit 14 is from a pre-registered CPU. Specifically, the access determination unit 143 determines whether the access is from a CPU corresponding to the identifier according to an identifier CPUID stored in the CPUID storage unit 142. The access determination unit 143 continues the process if the access is from a CPU corresponding to the registered identifier CPUID and rejects the process if the access is from a CPU not corresponding to the registered identifier CPUID.

The cryptographic key generation unit 144 generates a cryptographic key pair under predetermined instructions. In this example, a cryptographic key pair of a public key system (such as RSA or elliptic curve cryptography) is described, but it is not limited to this and can be similarly applied to cryptographic key pairs following other methods.

The encryption unit 145 encrypts the cryptographic key pair generated by the cryptographic key generation unit 144 with the common key stored in the common key storage unit 141 and outputs it to the CPU 12.

The decryption unit 146 decrypts the cryptographic key pair 161 encrypted with the common key stored in memory 16 using the common key stored in the common key storage unit 141 and outputs it to the CPU 12.

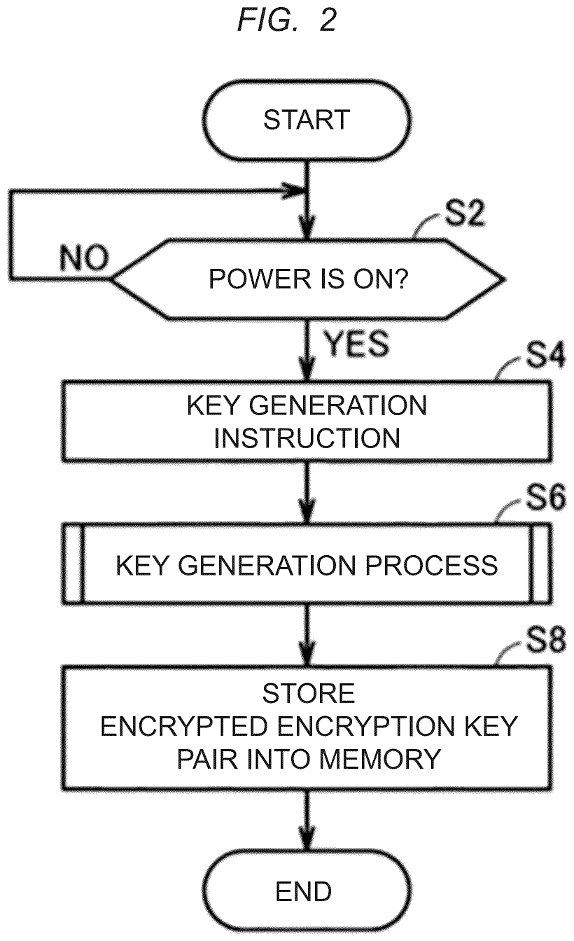

FIG. 2 is a flowchart illustrating the generation of a cryptographic key pair in a semiconductor device 15 according to an embodiment of the present disclosure. Referring to FIG. 2, the CPU 12 of the semiconductor device 15 determines whether the power is ON (step S2).

If the CPU 12 determines that the power is ON (YES in step S2), it outputs a key generation instruction to the cryptographic key protection circuit 14 (step S4). Specifically, the CPU 12 outputs a key generation instruction to the cryptographic key protection circuit 14 based on the program code stored in the memory 16, triggered by the initial power ON. Note that the CPU 12 can be not always required to output a key generation instruction to the cryptographic key protection circuit 14 at times of power on which are not initial.

Next, the encryption key protection circuit 14 executes the key generation process (step S6) according to the key generation instruction from the CPU 12. Details of the key generation process will be described later.

Next, the CPU 12 stores the encrypted encryption key pair output from the encryption key protection circuit 14 into memory 16 (step S8).

Then, the process ends (End).

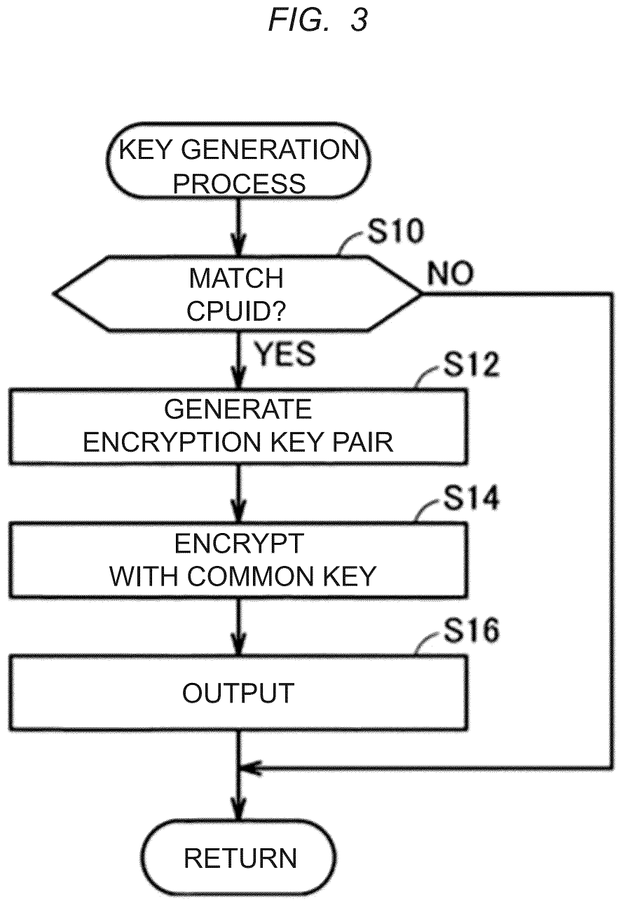

FIG. 3 is a flowchart illustrating the key generation process of the encryption key protection circuit 14 according to the embodiment of the present disclosure. Referring to FIG. 3, the encryption key protection circuit 14 determines whether the identifier CPUID of the CPU that outputs the key generation instruction matches the identifier CPUID stored in the identifier storage (step S10). Specifically, the access determination unit 143 determines whether the identifier CPUID of the CPU 12 input together with the key generation instruction matches the identifier CPUID stored in the CPUID storage unit 142.

In step S10, if the encryption key protection circuit 14 determines that the identifier CPUID of the CPU that output the key generation instruction does not match the CPUID stored in the CPUID storage unit 142 (NO in step S10), it determines that access is not permitted for the CPU and ends the process (Return). The access determination unit 143 determines that it is unauthorized access if the CPUID that outputs the key generation instruction does not match the CPUID stored in the CPUID storage unit 142 and does not instruct the encryption key generation unit 144 to generate the encryption key.

On the other hand, if the encryption key protection circuit 14 determines that the identifier CPUID of the CPU that outputs the key generation instruction matches the CPUID stored in the CPUID storage unit 142 (YES in step S10), it generates an encryption key pair (step S12). The access determination unit 143 instructs the encryption key generation unit 144 to generate the key, and the encryption key generation unit 144 generates an encryption key pair of a public key and a private key according to the instruction.

Next, the encryption key protection circuit 14 encrypts the encryption key pair with a common key (step S14). The encryption unit 145 encrypts the encryption key pair generated by the encryption key generation unit 144 using the common key stored in the common key storage unit 141.

Next, the encryption key protection circuit 14 outputs the encrypted encryption key pair (step S16). The encryption unit 145 outputs the encryption key pair encrypted with the common key to the CPU 12. Then, the process ends (Return).

The CPU 12 stores the encryption key pair encrypted with the common key output from the encryption key protection circuit 14 into memory 16.

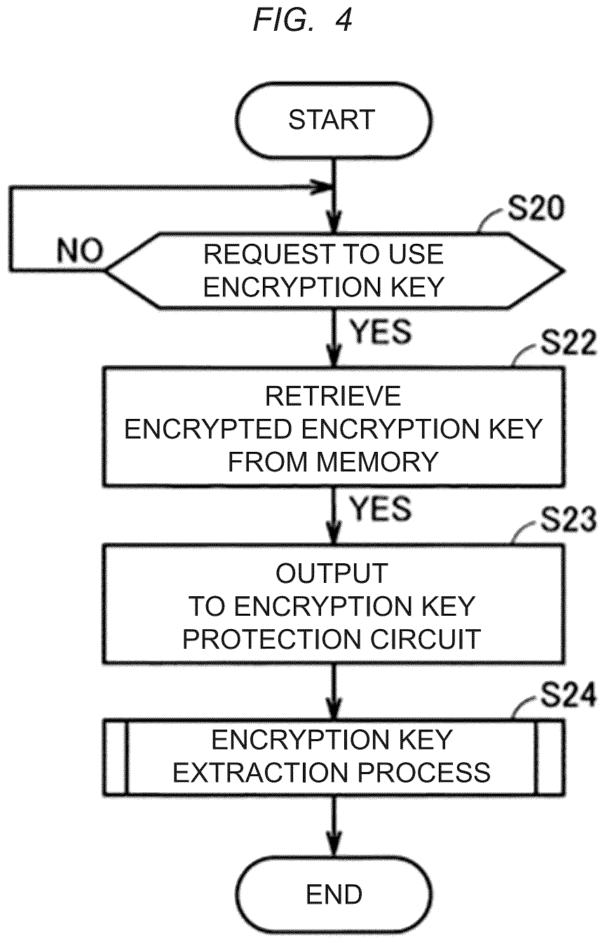

FIG. 4 is a flowchart illustrating the use of the encryption key pair of the semiconductor device 15 according to the embodiment of the present disclosure. Referring to FIG. 4, the CPU 12 of the semiconductor device 15 determines whether there is a request to use the encryption key (step S20).

In step S20, the CPU 12 maintains the state of step S20 until there is a request to use the encryption key.

On the other hand, if the CPU 12 determines that there is a request to use the encryption key (YES in step S20), it retrieves the encrypted encryption key pair from memory 16 (step S22).

Next, the CPU 12 outputs the retrieved encrypted encryption key pair to the encryption key protection circuit 14 (step S23).

Then, the encryption key protection circuit 14 executes the encryption key extraction process (step S24). Details of the encryption key extraction process will be described later.

Then, the process ends (End).

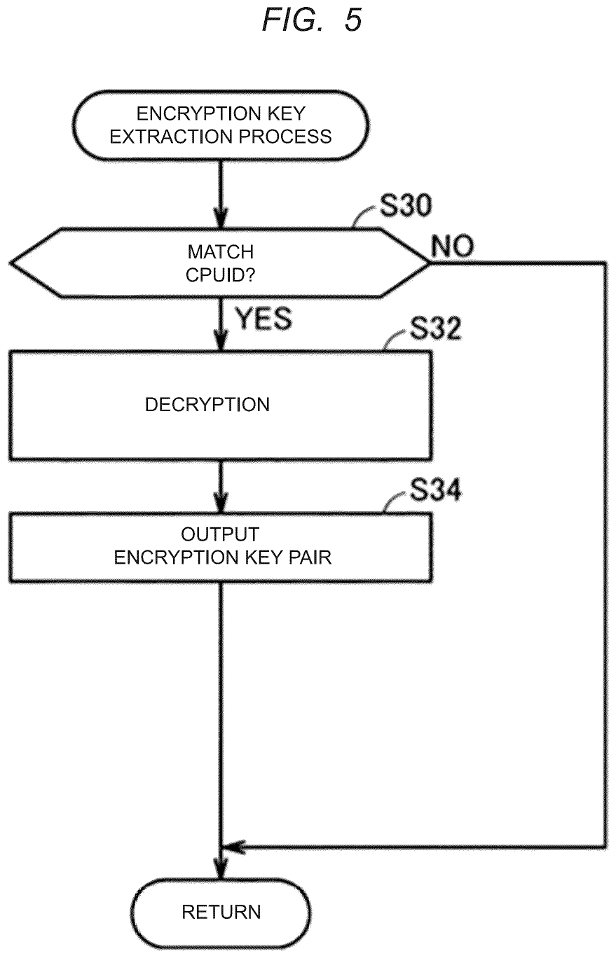

FIG. 5 is a flowchart illustrating the encryption key extraction process of the encryption key protection circuit 14 according to the embodiment of the present disclosure. Referring to FIG. 5, the encryption key protection circuit 14 determines whether the identifier CPUID of the CPU that outputted the key extraction instruction matches the identifier CPUID stored (step S30). Specifically, the access determination unit 143 determines whether the identifier CPUID of the CPU 12 input together with the key extraction instruction matches the identifier CPUID stored in the CPUID storage unit 142.

In step S30, if the encryption key protection circuit 14 determines that the identifier CPUID of the CPU that outputs the key extraction instruction does not match the CPUID stored in the CPUID storage unit 142 (NO in step S30), it determines that access is not permitted for the CPU and ends the process (Return). The access determination unit 143 determines that it is unauthorized access if the CPUID of the CPU that outputs the key extraction instruction does not match the CPUID stored in the CPUID storage unit 142, and does not instruct the decryption unit 146 to decrypt the encryption key.

On the other hand, if the encryption key protection circuit 14 determines that the identifier CPUID of the CPU that outputs the key generation instruction matches the CPUID stored in the CPUID storage unit 142 (YES in step S30), it decrypts the encryption key pair (step S32). The access determination unit 143 outputs the retrieved encrypted encryption key pair to the decryption unit 146, and the decryption unit 146 decrypts the encryption key pair encrypted with the common key.

Next, the encryption key protection circuit 14 outputs the decrypted encryption key pair (step S34). The decryption unit 146 outputs the decrypted encryption key pair to the CPU 12. Then, the process ends (Return).

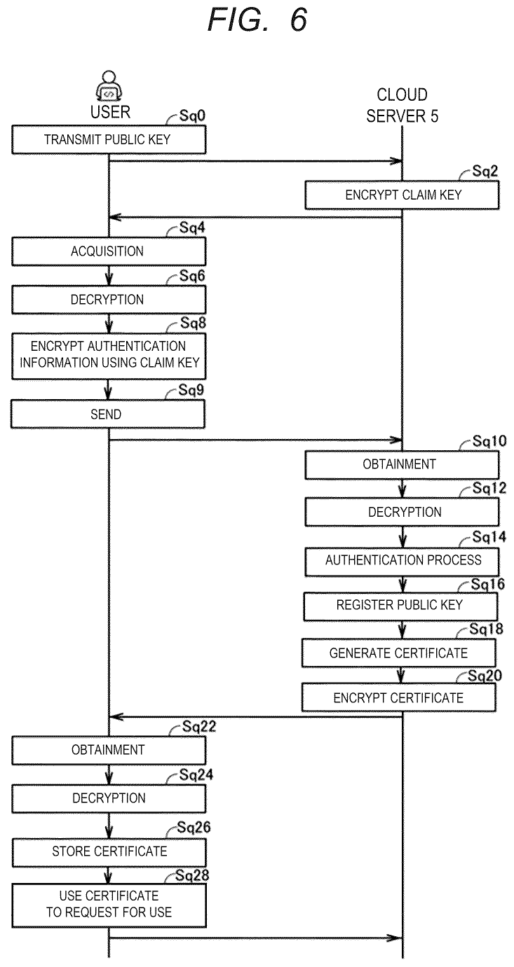

FIG. 6 is a diagram illustrating an example of the use of the encryption key pair according to the embodiment of the present disclosure. Referring to FIG. 6, this example describes a case where a user uses the semiconductor system 1 to perform authentication processing with the cloud server 5 using the encryption key pair.

Referring to FIG. 6, the semiconductor system 1 transmits the public key to the cloud server 5 according to the user's instruction (sequence Sq0). The public key is paired with the private key of the encryption key pair decrypted by the encryption key protection circuit 14 according to the flowchart in FIG. 5 for communication with the cloud server. Cloud server 5 receives the public key from semiconductor system 1, encrypts the claim key held on the cloud server side with the public key, and transmits it to semiconductor system 1 (sequence Sq2).

The semiconductor system 1 acquires the encrypted claim key (sequence Sq4). Next, semiconductor system 1 decrypts the encrypted claim key (sequence Sq6). Specifically, semiconductor system 1 decrypts the encrypted claim key using the private key paired with the public key. The private key used for decryption may be the private key of the encryption key pair decrypted by the encryption key protection circuit 14 according to the flowchart in FIG. 5.

Next, semiconductor system 1 encrypts the authentication information using the claim key (sequence Sq8).

Next, semiconductor system 1 sends the authentication information encrypted with the claim key to the cloud server 5 (sequence Sq9).

Cloud server 5 obtains authentication information encrypted with the claim key (sequence Sq10). Then, the cloud server 5 decrypts the authentication information using the claim key (sequence Sq12).

Next, cloud server 5 performs the authentication process based on the authentication information (sequence Sq14).

Then, cloud server 5 registers the public key of the authenticated semiconductor system 1 (sequence Sq16).

Next, cloud server 5 generates a certificate for the authenticated semiconductor system 1 (sequence Sq18).

Then, cloud server 5 encrypts the certificate with the registered public key and sends it to the semiconductor system 1 (sequence Sq20).

The semiconductor system 1 obtains the encrypted certificate sent from the cloud server 5 (sequence Sq22).

Next, semiconductor system 1 decrypts the encrypted certificate (sequence Sq24). Specifically, semiconductor system 1 uses the private key paired with the public key to decrypt the encrypted certificate. The private key used for decryption may be the private key from the encryption key pair decrypted in the encryption key protection circuit 14, as shown in the flowchart of FIG. 5.

Next, the semiconductor system 1 stores the decrypted certificate (sequence Sq26). Then, semiconductor system 1 uses the stored certificate to execute requests for using various services to the cloud server 5 (sequence Sq28).

Through this process, semiconductor system 1 can perform authentication processing with cloud server 5 while ensuring a robust secure state.

In the decryption process of the semiconductor system 1 in this example, the private key from the encryption key pair decrypted in the encryption key protection circuit 14 is used, as shown in the flowchart of FIG. 5 when using the private key. Therefore, decryption cannot be performed unless through the encryption key protection circuit 14, ensuring a high level of security. Furthermore, the generation of the encryption key pair according to this disclosure occurs within the encryption key protection circuit 14. Thus, it is difficult to obtain the encryption key pair without accessing the encryption key protection circuit 14. In this regard, access to the encryption key protection circuit 14 is restricted, CPUs which can access are limited in advance, and unauthorized CPUs cannot access. In other words, obtaining the encryption key pair from the encryption key protection circuit 14 is challenging, allowing for a high level of security to be maintained in a simple manner.

Additionally, since the encryption key pair generated by the encryption key protection circuit 14 is stored in an encrypted state in memory 16, it is impossible to decipher the encryption key pair stored in memory 16, ensuring a high level of security.

Moreover, the method according to this disclosure does not have the raw data of the encryption key pair presented within the encryption key protection circuit 14, so even if the interior of the encryption key protection circuit 14 could be analyzed, a secure state can still be maintained.

Although the present disclosure has been specifically described based on the embodiments described above, the present disclosure is not limited to the embodiments, and it is needless to say that various modifications can be made without departing from the gist thereof.

What is claimed is:

1. A method implemented by a semiconductor device comprising an encryption key protection circuit, a processor, and a memory, comprising:
instructing, by the processor, the encryption key protection circuit to generate an encryption key pair;
generating, by the encryption key protection circuit, the encryption key pair internally according to the instruction;
encrypting, by the encryption key protection circuit, the generated encryption key pair using a common key;
storing, by the processor, the encrypted encryption key pair output from the encryption key protection circuit in the memory;
receiving, by the encryption key protection circuit, when using the encryption key pair, the encrypted encryption key pair stored in the memory; and
decrypting, using the common key by the encryption key protection circuit, the encrypted encryption key pair received from the memory.

2. The method according to claim 1, wherein the instructing includes instructing by the processor the encryption key protection circuit to generate the encryption key upon an initial power-on of the semiconductor device by the processor.

3. The method according to claim 1, further comprising receiving by the encryption key protection circuit the instruction from the processor,
wherein the receiving includes accepting of instructions from the processor that has been pre-authorized for access and does not include accepting of instructions from the processor that has not been pre-authorized for access.

4. The method according to claim 2, wherein the instructing includes, by the processor, reading of program code stored in the memory upon an initial power-on of the semiconductor device and instructing the encryption key protection circuit to generate the encryption key.

5. The method according to claim 1, wherein the common key is stored within the encryption key protection circuit in a state that cannot be read from outside the semiconductor device.

6. A semiconductor device comprising:
an encryption key protection circuit;
a processor that instructs the encryption key protection circuit to generate an encryption key pair; and
a memory,
wherein the encryption key protection circuit comprises:
an encryption key generation unit that generates the encryption key pair internally according to instructions from the processor;
an encryption unit that encrypts the generated encryption key pair using a common key and outputs the encrypted encryption key pair for storage in the memory; and
a decryption unit that decrypts the encrypted encryption key pair stored in the memory using the common key when utilizing the encryption key pair.

7. The semiconductor device according to claim 6, wherein the processor instructs the encryption key protection circuit to generate the encryption key upon an initial power-on of the semiconductor device.

8. The semiconductor device according to claim 6, wherein the encryption key protection circuit accepts instructions from the processor that has been pre-authorized for access and does not accept instructions from the processor that has not been pre-authorized for access.

9. The semiconductor device according to claim 6, wherein the processor reads program code stored in the memory upon an initial power-on of the semiconductor device and instructs the encryption key protection circuit to generate the encryption key.

10. The semiconductor device according to claim 6, wherein the common key is stored within the encryption key protection circuit in a state that cannot be read from outside the semiconductor device.

11. A method implemented by a semiconductor device comprising a protection circuit with guaranteed appropriate security strength, a processor, and a memory, comprising:
instructing, by the processor, the protection circuit to generate an encryption key pair;
generating, by the protection circuit, an encryption key pair internally according to the instruction;
encrypting, by the protection circuit, the generated encryption key pair using a common key;
storing, by the processor, the encrypted encryption key pair output from the protection circuit in the memory;
receiving, by the protection circuit, when using the encryption key pair, the encrypted encryption key pair stored in the memory; and
decrypting, using the common key by the protection circuit, the encrypted encryption key pair received from the memory.

12. The method according to claim 11, wherein the instructing includes instructing by the processor the protection circuit to generate the encryption key upon an initial power-on of the semiconductor device by the processor.

13. The method according to claim 11, further comprising receiving by the protection circuit the instruction from the processor,
wherein the receiving includes accepting of instructions from the processor that has been pre-authorized for access and does not include accepting of instructions from the processor that has not been pre-authorized for access.

14. The method according to claim 12, wherein the instructing includes, by the processor, reading of program code stored in the memory upon an initial power-on of the semiconductor device and instructing the protection circuit to generate the encryption key.

15. The method according to claim 11, wherein the common key is stored within the protection circuit in a state that cannot be read from outside the semiconductor device.

16. A semiconductor device comprising:
a protection circuit with guaranteed appropriate security strength;
a processor that instructs the protection circuit to generate an encryption key pair; and
a memory,
wherein the protection circuit comprises:
an encryption key generation unit that generates the encryption key pair internally according to instructions from the processor;
an encryption unit that encrypts the generated encryption key pair using a common key and outputs the encrypted encryption key pair for storage in the memory; and
a decryption unit that decrypts the encrypted encryption key pair stored in the memory using the common key when utilizing the encryption key pair.
